(19) United States
(12) Patent Application Publication
(10) Pub. No.: US 2011/0128373 A1
(43) Pub. Date: Jun. 2, 2011

(54) Determining Meat Tenderness

(75) Inventor: David A. Goldberg, Boulder, CO (US)

(73) Assignee: Tenera Technology, LLC

(21) Appl. No.: 12/950,872

(22) Filed: Nov. 19, 2010

Related U.S. Application Data
(60) Provisional application No. 61/283,079, filed on Nov. 28, 2009.

(51) Int. Cl. H04N 7/18; G06K 9/00

(52) U.S. Cl. 348/135; 382/110; 348/E07.001

(57) ABSTRACT

The present methods and systems relate to the automated determination of meat tenderness through the use of high-resolution imaging of meat surfaces. This imaging is performed at a resolution such that the ultra-structural organization of muscle fibers can be observed. Features are extracted from these images, which feature extraction can be aided by the use of texture analysis or wavelet analysis algorithms. In addition, observation of the colors of different areas or constituents of the muscle fibers can provide features. A laser scanner can be used instead of imaging methods, wherein data obtained from such scanner can be analyzed as linear waveforms, rather than two-dimensional arrays of information. These features are then used to estimate tenderness using decision algorithms.

### RELATED PATENT APPLICATIONS

This application is related to and claims priority from U.S. patent application Ser. No. 12/667,157 filed Dec. 29, 2009, which is a U.S. national phase application of International Application PCT/US2008/008279 filed Jul. 3, 2008 claiming priority from U.S. Provisional Patent Application No. 60/958,398 filed Jul. 3, 2007, from U.S. Provisional Patent Application No. 60/961,582 filed Jul. 23, 2007, and from U.S. Provisional Patent Application No. 60/962,849 filed Jul. 31, 2007. The present application also claims priority to U.S. Provisional Patent Application No. 61/283,079, filed Nov. 28, 2009, the contents of all of the applications mentioned above are incorporated into this disclosure by reference.

### TECHNICAL FIELD

The present invention relates to the grading of meat tenderness using analysis of high-resolution images of meat surfaces.

### BACKGROUND

The beef industry would strongly benefit from an objective measure of tenderness that can be used to establish the value of a carcass, and assist cattlemen in breeding better stock. Such a measure will eventually improve the quality of all beef being sold, and increase consumer's satisfaction with beef products. A number of recent consumer tests confirm that there is a strong preference for a tender steak, and that they would pay a substantial premium for tender meat.

A long-standing method of estimating meat tenderness, as used in USDA grading, uses manual visual inspection of meat to look at marbling and carcass maturity to arrive at a quality grade (e.g. prime, choice, select, etc.). This official grading, however, has been shown to have little predictive accuracy in estimating meat tenderness. Thus, there have been considerable efforts over the last decades to find a better means of determining meat tenderness, with particular interest in automated means.

More recent methods of measuring beef tenderness include shear tests (e.g. the Warner-Bratzler Shear test—WBS, or the Slice Shear Force test—SSF), ultrasound measurement (e.g. U.S. Pat. No. 6,167,759 to Bond, et al), meat color measurement (e.g. U.S. Pat. No. 6,198,834 to Belk, et al), and genetic tests for a variant of the calpastatin gene that correlates with meat tenderness (e.g. U.S. Pat. No. 7,238,479 to Smith, et al). However, each of these tests suffer from at least one of the problems of high cost, long duration of test, low accuracy or destruction of the meat samples. In general, a test of commercial value would take place in 10 minutes or less, be largely automated, has associated costs of less than approximately 50 cents to one dollar in 2008 currency per measurement, is non-destructive, and has an accuracy of greater than 95% in specifying that a particular meat sample is across a particular threshold of tenderness. Of these, only color measurement has proven suitable for use in commercial bulk production, and its accuracy has repeatedly been shown to be too low to provide useful guarantees to consumers of acceptable meat tenderness.

It would be of considerable benefit to both the meat industry, as well as consumers, to have an automated means of accurately measuring the tenderness of meat. It is to the solution of this problem that the present invention is directed.

### SUMMARY OF THE INVENTION

It would be preferable for the present invention to provide sufficient accuracy of meat tenderness determination in a production environment.

It would also be preferable for the present invention to provide inexpensive meat tenderness determination in a production environment.

It would further be preferable for the present invention to provide non-destructive meat tenderness determination in a production environment.

It would additionally be preferable for the present invention to determine meat tenderness using an automated system in a production environment.

It would yet further be preferable for the present invention to provide a determination of meat tenderness that is rapid and can be performed on a meat processing line between the time that the rib-eye used in grading is exposed and the disposition of the carcass is determined subsequent to USDA grading.

Additional objects, advantages and novel features of this invention shall be set forth in part in the description that follows, and will become apparent to those skilled in the art upon examination of the following specification or may be learned through the practice of the invention. The objects and advantages of the invention may be realized and attained by means of the instrumentalities, combinations, and methods particularly pointed out in the appended claims.

In accordance with the purposes of the present invention, as embodied and broadly described herein, the present invention is generally directed to a method for determining tenderness of a meat sample in which a surface of the sample is exposed. Upon this exposure, the meat surface is imaged with a high resolution imager capable of resolving muscle fiber ultrastructure. From the resultant high-resolution images, at least one feature is extracted in a means that resolves muscle fiber ultrastructure. Finally, meat tenderness is determined using an automated decision algorithm that operates on the at least one extracted feature.

The imager preferably has a resolution of less than 25 microns, and more preferably a resolution of less than 10 microns. The imager can comprise a multi-spectral imager.

Prior to imaging, at least a portion of the meat surface can be treating with a visual indicator of a physiological state, wherein the indicator is visible by the imaging. This treatment with the indicator can be applied in a predetermined pattern with respect to another portion of the meat surface that is not treated with the indicator. The indicator can be selected from the group consisting of pH indicators, calcium indicators, and protease indicators. The physiological state can be related to specific parts of muscle fiber ultrastructure.

The at least one extracted feature can comprise a comparison of a feature within muscle fiber core and the feature in endomysium. This feature can be a color value.

The at least one extracted feature can comprise a statistical measure related to a topological feature of muscle fibers. This topological feature can be selected from the group consisting of muscle fiber diameter, muscle fiber area, muscle fiber degree of orientation, thickness of the endomysium, and ratio of area in endomysium to area in muscle fiber core.

The imager can be a fluorescence imager.

The featuring extraction can further comprise texture analysis, which can comprise the use of local pattern analysis, or it can comprise the use of transforms of the images, which can be wavelet transforms or Fourier transforms.

The present invention can also be directed to a method for determining tenderness of a meat sample in which a surface of the sample is exposed. A first portion of the surface can be treated with a visual indicator of a physiological state, which first portion can be imaged. A second portion of the meat surface that has not been treated with the indicator can also be imaged. The meat tenderness can then be determined using an automated algorithm that uses the image of the first portion and the image of the second portion.

The indicator can be a pH indicator, wherein the imaging can be performed by a color imager.

The indicator can be a protease indicator, wherein the imaging is performed by a fluorescence imager.

The indicator can be accompanied by a carrier dye.

The indicator can be selected from a group consisting of anthocyanins, hematochromes, flavenoids, azolitmins, orceins, and triphenylmethanes.

The imaging can be at a resolution of less than 25. Also, the imaging can be performed so as to resolve muscle fiber ultrastructure.

The present invention can furthermore be directed to a method for determining tenderness of a meat sample in which a surface of the sample is exposed. The surface can be treated with a fluorescent indicator of a physiological state. A first portion of the treated surface can be illuminated at a wavelength that causes excitation of the indicator, and this portion can then be imaged. The meat tenderness can then be determined using an automated algorithm that uses the image of the first portion. The illuminating can comprises laser illumination.

The present invention can in addition be directed to a method for determining tenderness of a meat sample in which a surface of the sample is exposed. The meat surface can be imaged with a high resolution imager capable of imaging individual muscle fibers. From these images so obtained, at least one feature can be computed from the high resolution images. From this at least one feature, meat tenderness can be determined using an automated decision algorithm that operates on the extracted features.

The imaging is preferably performed with a resolution of less than 25 microns. The surface can be treated with a visual indicator of a physiological state.

The present invention can furthermore be directed to a system for determining meat tenderness from a sample of meat in which a surface of the sample is exposed. The system can comprise an imager configured to obtain high resolution images of the surface and that resolves individual muscle fibers. The system can also comprise an image analyzer coupled to the imager for extracting features from the high resolution images relating to ultrastructural aspects of individual muscle fibers. Finally, the system can comprise a decision algorithm executor coupled to the image analyzer, the executor being configured to provide a measure of meat tenderness from the extracted features. The system can additionally comprise an applicator for applying a visual indicator to the surface of meat prior to imaging by the imager. This visual indicator can be a pH indicator.

The present invention can yet furthermore be directed to a system for determining meat tenderness from a sample of meat in which a surface of the sample is exposed. The system can comprise a laser scanner configured to obtain high resolution waveforms that resolves the parts of individual muscle fibers along a line across the meat. The waveform can be analyzed to measure the approximate sizes of the muscle fiber components. The waveform can also be analyzed to determine the differences in signal strength from different muscle fiber components. The size of the laser beam on the meat is preferably less than 10 microns, and more preferably less than 5 microns and most preferably less than 2 microns. More than one laser can be employed, using different wavelengths. The lasers can be coupled so that they are coincident on the same meat location, allowing direct measurement of the ratio of signal strength of the two wavelengths at the same location. Alternatively, the lasers can be uncoupled, so that the beams are not coincident on the meat.

The present invention can also be directed to a system for determining the gross characteristics of meat, including yield and marbling. The system can comprise a laser scanner configured to obtain high resolution waveforms that resolves fat from meat through waveform characteristics that can comprise waveform spatial frequency and amplitude variance. A grid of laser beams is imposed on the meat, which beams can be rectilinear or other shape, which is then interpreted in teens of fat and lean meat. The information can be interpolated to give fat versus lean meat at every location.

The present invention is additionally directed to a method for determining tenderness of a meat sample in which a surface of the sample is exposed. The method can comprise scanning the surface with a laser whose beam diameter is smaller than smaller than a predetermined diameter, recording the light reflected from the surface as a waveform, extracting at least one feature from the waveform, wherein the feature is related to muscle fiber ultrastructure, and determining meat tenderness using an automated decision algorithm that operates on the at least one extracted feature.

The predetermined diameter of the laser beam can be less than 25 microns. The at least one extracted feature can comprise a comparison of a feature within muscle fiber core and the feature in endomysium. The at least one extracted feature can comprise a statistical measure related to a topological feature of muscle fibers. The topological feature of muscle fibers can be selected from the group consisting of muscle fiber diameter, muscle fiber area, muscle fiber degree of orientation, thickness of the endomysium, and ratio of area in endomysium to area in muscle fiber core. Furthermore, the method can determine a gross characteristic of the meat selected from the group consisting of yield and marbling.

The present invention is yet additionally furthermore directed to a system for determining meat tenderness from a sample of meat in which a surface of the sample is exposed. The system can comprise a laser scanner with a beam diameter less than a predetermined diameter. The system can also comprise a recorder that records the laser light reflected from the surface, creating a waveform. An analyzer coupled to the recorder can extract features from the waveform related to ultrastructural aspects of individual muscle fibers. A decision algorithm executor can be coupled to the analyzer, the executor being configured to determine a measure of meat tenderness from the extracted features.

The predetermined diameter of the laser beam can be less than 25 microns. The at least one extracted feature can comprise a comparison of a feature within muscle fiber core and the feature in endomysium. The at least one extracted feature can comprise a statistical measure related to a topological feature of muscle fibers. The topological feature of muscle fibers can be selected from the group consisting of muscle fiber diameter, muscle fiber area, muscle fiber degree of orientation, thickness of the endomysium, and ratio of area in endomysium to area in muscle fiber core. Furthermore, the system can determine a gross characteristic of the meat selected from the group consisting of yield and marbling.

### BRIEF DESCRIPTION OF THE DRAWINGS

FIG. 1 is a schematic flow diagram of the steps of an embodiment of the present invention.

FIG. 2 is a high resolution image of a meat sample, wherein the image is obtained according to the present invention.

FIG. 3 is a schematic diagram of one embodiment of a system of the present invention.

### DESCRIPTION OF THE INVENTION

### Overview of the Steps

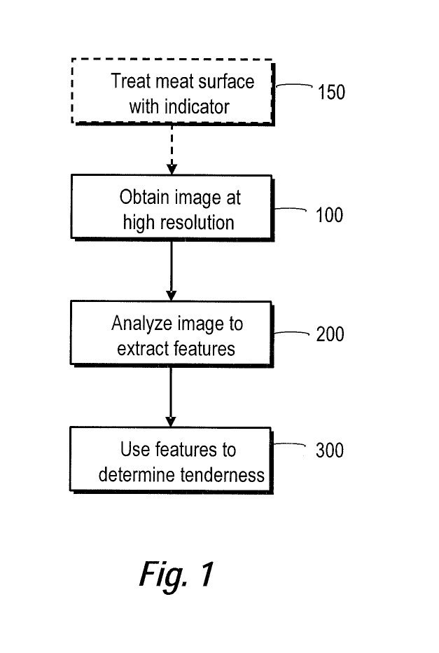

An overview of the steps of an embodiment of the present invention are illustrated in FIG. 1, a schematic flow diagram.

In a first step 100, a high resolution image of a portion of meat is obtained. This image can be captured in the normal optical spectrum, or it can alternatively include portions of the infrared or ultraviolet spectrum. Additionally, in an optional prior step 150, indicators can be applied to the meat sample, wherein such indicators can be used to detect biochemical or physiological components or processes that cannot be determined by direct observation of the meat in the absence of such indicators.

In a second step 200, these high resolution images are analyzed to extract features. These features can comprise detailed spatial variations in intensity and color. These features can additionally be used to segment the image into parts of an image related to lean meat and non-lean meat, and is especially useful in determining small scale features (e.g. deposits of non-lean meat that are substantially less than 1 mm in extent).

In the third step 300, these features are combined using a decision algorithm to determine the tenderness of the meat. Optionally, the features obtained from a high resolution image can be supplemented with other features obtained by other means than high-resolution imaging.

### Obtaining High Resolution Images

In order to obtain high-resolution images of the meat in the step 100, a CCD or CMOS imager is directed on the meat, preferably on the cut between the 12th and 13th ribs in the manner typical of that for USDA grading, which exposes a sample of the meat for tenderness determination. Conveniently, just prior to or just subsequent to the grading by the USDA inspector, the imager captures an image of the meat. It should be noted that other muscle types can be analyzed by the methods of the present invention. Thus, tenderness analysis of the present invention can be applied to one muscle type and extrapolated by statistically determined tenderness ratios to the tenderness of other muscle types, or alternatively, the present invention can be applied separately to different muscle types from the same carcass.

It should also be understood that the orientation of the meat surface with respect to the imager should be roughly similar from image to image. Given that the actual grain of the meat (i.e. the orientation of the individual muscle fibers) will vary from carcass to carcass, this generally means that cuts through the meat should be made roughly consistently from animal to animal with respect to general anatomical features. It should be noted that such consistency is normally provided through the surfaces available in conventional USDA grading.

The imager can be an RGB imager operating primarily in visible light, an NIR imager, a grayscale imager, or other imager that has one or more electronic imaging devices that outputs pixel intensity values in one or more ranges of the light spectrum. Furthermore, for an RGB imager, the imaging electronics can either be a single chip with an interleaved array of red, green and blue sensors, or alternatively, three different monolithic red, green and blue chips can be utilized. As will be described below, the behavior of the imager can be modified by different types of illumination or light filtering, such as from spectrum-limited illumination (as might be used, for example, in fluorescence imaging) or polarized illumination (e.g. for polarization imaging).

It should be appreciated that the use of multi-spectral imaging—that is, obtaining images using imagers that can distinguish and image light at more than one wavelength—has the ability to obtain more information generally than those imagers that are limited either to one or a limited range of wavelengths, or an imager that treats a wide range of wavelengths identically (e.g. a grayscale imager). Thus, it is preferable for the imager to be a multi-spectral imager.

The images so taken have a resolution preferably of under 100 microns and more preferably of under 25 microns and most preferably of under 12 microns. This resolution is chosen so that ultrastructural features of the muscle such as muscle fibers and the surrounding endomysium and perimysium are visible. Described alternatively, it is preferable for the imaging to be able to distinguish physiologically important features at the level of muscle fibers and their components (e.g. muscle fiber core and endomysium).

In order to obtain images of this resolution, a high megapixel camera is typically used, and generally cameras with a 6 million or more pixels is preferable and 10 million or more pixels is more preferable. Even at this high pixel count, with the desired resolution only portions of the ribeye exposed in the USDA grading process will be able to be imaged. In general, that part of the ribeye that is generally used for tenderness measurement by methods such as the sliced shear force (SSF) or Warner-Bratzler shear force measurement should be used, although other portions of the ribeye can be utilized, or even additional muscle types. Given that the image should be of lean muscle, and that fat deposits internal within the muscle can be extensive in highly marbled meat, it preferable that an area of at least 4 cm² is preferable to be imaged, and more preferably at least 6 cm², and most preferably more than 8 cm².

It should be appreciated, however, that multiple areas of the muscle can be imaged either sequentially by the same imager, or in parallel, by more than one imager that are directed at different areas of the meat surface. In such cases, the methods of analysis described below can be analyzed roughly as if they are from a single image.

In general, the resolution of the image will vary according to the distance of the camera from the meat surface. So as to maintain a constant resolution, a method of maintaining a relatively constant distance of the camera from the meat is preferable. Such a method can comprise either physical standoffs that touch the meat, by a motorized Z-axis carriage coupled with electronic distance measuring (e.g. via determining when an image is in focus, or alternatively determining when two non-parallel laser beams are coincident on the meat), or other convenient means. It is preferable that the resolution of the image not vary more than 25% within an image or between images, and more preferable that the variation be less than 10% and most preferable that the variation be less than 5%. This effect can be somewhat reduced by using a narrow angle lens, and can be further reduced or eliminated by using a telecentric lens, which is a preferably an object-space telecentric lens. Alternatively, a size scale can be placed on the meat so that the images can be examined and scaled so as to correct for differences of resolution on the surface. The use of a reference is highly preferred, which reference can include not only size references, but also focus references, in order to ensure that the image was properly taken, and to correct for slight image-to-image changes in resolution. Conveniently, these size references can also comprise color references, as described above.

While it is preferable for the camera to be capable of capturing color, it is also acceptable for the camera to be a grayscale camera. The advantage of the grayscale camera is generally that the density of pixels can be higher than that in a color camera. As will be discussed below, many of the features that are most useful in determining tenderness rely only on intensity differences rather than color differences, although the use of color differences allows for a greater range of features to be used in the tenderness decision algorithms. It is also within the spirit of the present invention that multiple cameras be used to image the meat, wherein one camera is a high resolution grayscale camera, and the second camera is a much lower resolution color camera that is capable of capturing an image of the entire meat surface. The image from the second color camera can be used for examining features of the meat involving color that are related to tenderness.

It is also a teaching of the present invention that a gray scale imager can be outfitted with color bandpass filters for different spectral bands, so that the imager obtains information from only certain wavelengths. If multiple filters are sequentially passed over the lens, which can be arranged through the positioning of multiple filters on a rotating wheel, for example, multiple images of the same area of meat can be obtained from multiple wavelengths.

It is preferable for the illumination of the ribeye surface to be as even as possible. This is often accomplished by placing an enclosure around the meat and the camera, within which sources of illumination are arrayed. The sources of illumination can be either continuous or flash. Convenient sources include fluorescent lamps and LED arrays, as well as flash and arc lamps. It should be noted that nonuniformity in illumination can oftentimes be eliminated in postprocessing of the meat images, and furthermore, many of the features that can be detected in the meat as will be described below are relatively insensitive to variations in illumination. For example, in local binary patterns, pixel-to-pixel variations within a limited range of pixel distances are examined, so that long-spatial-wavelength variations in illumination have limited effects on the analysis.

Glare on the surface of the meat can be a problem in image acquisition, and is generally a more important issue that illumination uniformity. To deal with this, the illumination source and imager can either one or both be outfitted with a polarization filter to reduce the amount of glare in the image. This is particularly effective with point, near-point or unidirectional illuminators. An alternative to this is to provide highly diffuse illuminators.

It should be noted that the imaging is preferably taken over a short period of time, since the carcasses on which the measurements are taken are often moving continuously, and the cameras are manually positioned. Thus, it is preferable for the exposure timing to be under 125 milliseconds, and more preferably under 50 milliseconds, and most preferably under 10 milliseconds. This can be accomplished either by increasing the illumination, or by increasing the imager aperture.

When the meat surface is prepared, it often has considerable variations in height, that are often on the order of 3-5 mm relief. To maintain most or all of the surface in focus at one time, the depth of focus must be large enough to accommodate this relief. Therefore, it is preferable for the depth of focus to be at least 3 mm, and more preferable for the depth of focus to be at least 5 mm, and most preferable for the depth of focus to be at least 7 mm.

The camera will generally be connected to a computer through a high-speed cable linkage, such as USB 2, FireWire, or through cable linkage to an image capture card on the computer, although high-speed wireless linkages (e.g. 802.11n) are also acceptable. The images should be compressed as little as possible, and while minimal JPEG or other compression can be acceptable prior to feature detection so as to allow for rapid image transfer, it is most preferable for there to be no image compression.

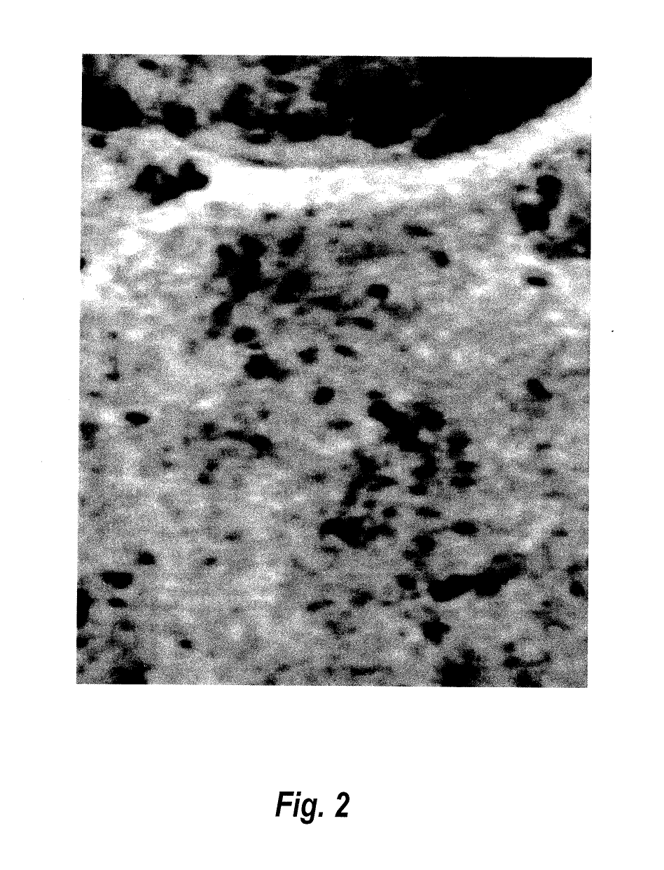

An example of an image obtained in the manner of the present invention is given in FIG. 2, an image of a meat sample. The image was taken with the macro lens of a Canon A640 camera, such that the resolution was approximately 12 microns. The sample was illuminated with a fluorescent ring light. The green channel was subtracted from the red channel, giving an approximate hue (i.e. in this case, the hue distance from red), and the contrast and brightness adjusted somewhat for presentation. The “texture” of the meat is due to the appearance of muscle fibers, with an approximate diameter of 5 to 12 pixels (60-150 microns).

Given that absolute color values may be useful, the use of reference color panels when obtaining images is preferred. Such reference color panels can comprises a white reference, a black reference, gray scale references, or a combination of the three, and are well known in the prior art.

### Use of Indicators

Indicators may be applied to the meat prior to imaging in the step 150. These indicators can provide qualitative or quantitative information about the physiological state of the meat, which physiological states can be correlated with the meat tenderness.

For example, it is well-known that the pH of the meat changes in the post-mortem period, and that such pH changes are related to meat tenderness. The use of color indicators of pH is very well known in the art, and such pH indicators can be applied to the meat surface through spraying or through direct application. If the indicator is applied with minimal accompanying solution and without a buffer, the pH in the indicator environment will be relatively consistent with the pH of the intracellular contents of the muscle.

There are many pH indicators, many of which are relatively benign. For example, the anthocyanins are found in many plants (e.g. cabbage), and have been used as pH indicators. In addition, azolitmin and orcein are natural products of lichens and can serve as pH indicators. Additionally, the anthocyanins can be modified to affect the pH range over which their colors change. There are many other pH indicators, both natural and artificial that can be utilized within the prior art. It is preferable for the indicator to change colors over the range from pH 5.5-6.0, and more preferably over the range from 5.5 to 6.5, which are the physiologically important pH's related to tenderness. Other pH indicators of note include hematochromes, flavenoids other than anthocyanins, and triphenylmethanes (bromocresol green, bromocresol purple, etc.).

It should be noted that the pH indicator will be viewed over a background of the meat color, and so it is preferable for the indicator to have colors that contrast with the color of the meat, so that they can be distinguished from the meat color. It should be noted that the pH indicator can either operate in visible light, in ultraviolet light, or alternatively, can be a fluorescent indicator. The advantage of the fluorescent indicator is that it will be more easily observed over the background of the meat.

In order to distinguish the light response of the pH indicator from that of the meat, the pH indicator can be applied in a patterned fashion, so that the light response of the meat can be “subtracted” from that of the meat plus indicator. For example, if the pH indicator is sprayed onto the meat, a mask can be first placed over the meat so that the pH indicator is localized to the pattern of the mask. Alternatively, the pH indicator can be applied directly to the meat, either through direct application or via, for example, an ink jet process, so that areas of indicator and no indicator are in a predetermined pattern. Thus, in both of these cases it is preferable for there to be areas or portions of the meat in which the indicator is present, and areas or portions of the meat in which the indicator is absent.

It should be appreciated that the difference in color between untreated meat and meat treated with the indicator is then the information of note (for example, to be used in the feature extraction step 200). The term difference is not necessarily literal, in that the difference can be a ratio, an arithmetical difference, or a complex function determined from a variety of color attributes of the treated and untreated meat that might, for example, be output from a neural network, a decision tree, or some other decision algorithm.

To determine the amount of dye that is applied at a given location, it is preferable to include a “carrier” dye that is approved for use in food, and which comprises colors that are distinguishable from that of the meat and that of the indicator. For example, if the indicator varies between red and blue, and given that the meat is primarily red in hue, an indicator that had a large green component would aid in the determination of the amount of indicator that is present. If the indicator is fluorescent, the carrier dye can be likewise fluorescent.

Another type of indicator is a calcium chromophore, which quantitatively indicates the presence of calcium ions. Given that endogenous proteases are highly dependent on calcium levels (e.g. calpastatin is a calcium-binding protein, and its activity is modulated by calcium levels), the calcium concentrations are related to protease activity, and thereby to meat tenderness. Examples of calcium indicators include the fluorescent calcium chromaphores fura-2, indo-1, fluo-3, and calcium green-1.

Protease activity is well-known to have an effect on tenderness levels. In order to determine protease activity, the use of fluoregenic protease indicators can be used. These indicators are generally fluorogenic compounds with internal quenching of fluorescence, such that cleavage of an internal peptide removes the quenching. Examples of such fluoregenic compounds include compounds described in U.S. Pat. No. 5,605,809 to Komoriya, et al., U.S. Pat. No. 5,871,946 to Lucas, et al, U.S. Pat. No. 6,787,329 to Wei, et al., and U.S. Pat. No. 6,979,530 to Yan.

It should be importantly noted that these indicators need not be used with high resolution imaging, and can be used in conjunction with low resolution imaging, as in a grading system from E+V (Orienburg, Germany). With low resolution imaging, the association of the pH, calcium, protease or other indicator will not be known with respect to ultrastructural components, but will be known on a macrostructural/bulk level within the muscle.

Multiple indicators can be used on the same piece of meat, and can be imaged synchronously. For instance, pH and calcium indicators can be placed on the meat sample in a spatial ordered fashion so that both can be read form the same image or from sequential images. Alternatively, the different indicators can be read from different spectral bands, or with different fluorescent excitation or emission spectra, and be so distinguished. This allows the use of multiple features to be acquired.

Images so acquired will, in general, have information both from areas with indicators and areas lacking indicators. Images from the areas with indicators can either be used to provide bulk information about the meat sample (e.g. the bulk pH or calcium levels), or alternatively, can be analyzed in a manner similar to the high-resolution images as described below, providing information at an ultrastructural level.

The location and distribution of patterns of meat with and without indicators can be indicated with calibration marks, which are conveniently food-safe dyes. It is also a teaching of the present invention that a fluorescent indicator can be illuminated by laser light so as to excite the fluorescent indicator, so that only a small area is brightly illuminated on an otherwise non-illuminated background. This provides high-illumination along with a good background control. There are a number of methods to excite such fluorescent indicators, as are well-known in the prior art.

For example, bulk color of lean muscle as determined by low resolution imaging comprises a summation of the color information from both the core of the muscle fiber, as well as connective tissue in the perimysium, endomysium and epimysium. The color of the core muscle fiber is affected by the type of muscle fiber (slow/fast twitch and the glycolytic index of the muscle), as well as by the pH. By isolating the color in the muscle fiber core from that of the connective tissue, the color is decomposed into two spatially separated components. By measuring the pH of the tissue, the contributions of pH versus muscle physiology can be separated. Through this detailed analysis, the physiology of the muscle can be better understood, giving rise to a better determination of meat tenderness.

### Use of Spectrum-Limited Illumination

It should be noted that certain components of the meat can be selectively detected by using particular spectra of illumination, such as the infrared and the ultraviolet. In particular, it has long been noted that collagen autofluoresces when illuminated with UV light, and that the amount of this autofluorescence increases dramatically with increasing cross-linking that occurs when collagen becomes cross-linked over time. This information can be used in one of two ways.

In the first manner, the endomysium and perimysium are collagen rich, allowing the perimeters of the muscle fibers and fascicles (comprising largely endomysium and perimysium, respectively) to be better discerned. Thus, pixels of high autofluorescence can be distinguished from pixels of relatively low autofluorescence, so as to be able to distinguish muscle fiber core from the surrounding collagen-rich endomysium.

In a second manner, the extent and character of the collagen can be explicitly studied at an ultra-structural level using the high resolution images. As mentioned before, the degree of autofluorescence is related to the degree of cross-linking, and the degree of cross-linking is known in the prior art to be highly inversely correlated with meat tenderness. Furthermore, it has been theorized that the amount of collagen surrounding the muscle fiber core within the endomysium is correlated with meat tenderness, and since the area showing fluorescence (and/or the amount of fluorescence, when the resolution is not high enough to distinguish muscle fiber core from the surrounding endomysium) will indicate the amount of collagen, it will therefore be related to the degree of meat tenderness.

For the purpose therefore for obtaining high-resolution fluorescence images, the illuminator is a fluorescence illuminator, preferably illuminating with light having a wavelength of less than 400 nm, and more preferably with light in the range of 360-370 nm. This light can be generated either by a high-pressure lamp (e.g. xenon arc, deuterium arc, mercury-xenon arc, metal-halide arc, and tungsten-halogen lamps), or alternatively with low pressure fluorescent blacklights, which are conveniently of the BLB or BL350 designs. In all cases, an optical filter is preferably used to remove any higher wavelength (e.g. visible) light from impinging on the meat. It should be noted that to the extent possible, a drape and/or enclosure can be used to limit the amount of stray ambient light. Furthermore, given that the area of meat being examined is limited, a very small enclosure can make contact with the meat to form a protected area free from or reduced amounts of ambient light.

The primary fluorescence peak is determined by the type of collagen being examined (e.g. the primary fluorescent collagen species in muscle are Type I and Type III, and it is preferable to measure the fluorescence at 410-450 nm and more preferable at 410-430 nm for Type I collagen and preferably at 500-530 nm for tType III collagen. These measurements are aided by the use of bandpass filters, which also have the desirable effect of reducing the amount of ambient light impinging on the imager. It is also within the teaching of the present invention for the total fluorescence over all collagen types to be used, which is performed with the use of a bandpass optical filter preferably in the range of 410-550 nm. It should also be appreciated that a conventional RGB imager can be used, in which case the Type I collagen can be evidenced by autofluorescence in the blue channel, while the presence of Type III collagen can be evidenced by autofluorescence in the green channel.

### Use of Polarized Light

Both collagen and actin are known to be birefringent, wherein the degree of birefringence is a function of the degree of strain and the orientation of the fiber. In a muscle, the orientation of the actin-myosin in the muscle is generally longitudinal with respect to the muscle fiber, whereas the orientation of the collagen more circumferential. In order to measure the birefringence, a preferable technique is to create an arrangement similar to that of a polarimeter, wherein a polarization filter is placed between the light source and the object (i.e. in this case, the muscle surface), and a “crossing” polarizing filter is then placed in front of the imager. Only light that is optically rotated by the birefringent material then impinges on the imager. A single image can be obtained in such fashion, given an incidence angle of the light onto the meat, or alternatively, a series of images can be made at different angles of incidence, so as to provide a more complete description of the orientation of birefringent materials within the meat. In the case where more than one image is obtained, either a single imager can be used with different orientations, or preferably, multiple imagers can be used, so that images can be rapidly taken on the grading line where at most 3-4 seconds is available for obtaining images.

Birefringence can be used in a number of means. In a first means, the different orientations of the muscle fiber ultrastructural and biochemical components (e.g. contractile elements comprising actin-myosin fibers) and the endomysium/perimysium collagen components mean that the muscle fiber core can be distinguished from the surrounding endomysium/perimysium. Therefore, the differential birefringence can be observed at the ultrastructural level, so that muscle fiber core can be distinguished from the surrounding endomysium and perimysium.

In a second means, the birefringence also gives indication of the orientation of the birefringent material. It should be understood that the cut made for USDA grading intersects the muscle fibers at approximately a 45 degree angle, and the muscle fibers are therefore cut obliquely. The extent of birefringence can be used to detect the rough orientation of fibers, which can be related to the measured toughness. That is, the toughness of the meat as measured by standard shear force methods (e.g. Warner-Bratzler or Sliced Shear Force) depends in part how the cores or slices are made relative to the orientation of the fibers, and by measuring the orientation of the fibers relative to the cuts or relative to the surface (i.e. how oblique the fibers are relative to the surface), aspects of the toughness can be elucidated.

In a third means, the degree of birefringence is related to the extension or strain on the molecules, with higher birefringence generally indicating a higher degree of extension. It is known that toughness is related to the physiological state of the meat fibers, and various means of electrical stimulation are used to affect that physiological state. Thus, the degree of birefringence can therefore in part be related to the toughness of the meat.

As with the use of fluorescence, it is preferable to have an arrangement where the meat to be analyzed is hooded such that ambient illumination (i.e. non-polarized light) is minimized.

### Feature Extraction

### Separation of Lean Muscle from Non-Lean-Muscle Elements

While it is not necessary, it is preferable as a first step of feature extraction to separate parts of the image that are fat, gristle, nerves, blood vessels, blood splatter or other non-lean-muscle information from the lean muscle. The majority of these non-lean-muscle portions will be predominantly fat, and in second abundance, generally, gristle. Those non-lean-muscle portions of the image related to fat and gristle can generally be determined by separating the image either into hue, saturation and lightness values (throughout this discussion, lightness in the HSL color mapping is used interchangeably with that of value of the HSV classification system). The fat is generally distinguished from the rest of the meat by having a higher value and a lower saturation. Alternatively, the fat can be identified by larger green and blue intensity values. In general, the use of multiple criterion for fat determination is preferable, as this will limit false-positive and false-negative determinations. There are numerous methods for determining fat and gristle from images in the prior art, and any of these can be used for these purposes.

It should be noted that for purposes of tenderness analysis, it is preferable to have a high false positive rate of fat detection than a high false negative rate. In general, there will be an excess of information about lean muscle, and eliminating any background information that involves fat, gristle is important in that it provides more accurate information about the state of the lean muscle. In general, it is preferable to erode the areas attributed to fat by one to three pixels, so that the areas of fat are largely eliminated from the image.

It should be noted that the fat deposits so identified can vary greatly in size from individual deposits that are a square centimeter or more in area (and which are generally found in the previous art), to those deposits that are a fraction of a square millimeter (and which cannot be generally easily detected without high resolution images). These smaller fat deposits have largely been ignored in the prior art, and careful measurement of the size and distribution of these smaller fat deposits can be considered a feature of the meat that can be used for determining its tenderness.

Gristle can be identified by methods that are very similar to those used to identify fat. However, the parameters of hue, saturation, and lightness, or red, green, or blue, or magenta, cyan, or yellow will be somewhat different from that used for identifying fat. It should be noted that these parameters will vary according to the type and intensity of illumination from system to system, and that the correct parameters should be determined empirically.

### Color

It has been noted in the prior art that the color of the meat as determined either in the normal optical spectrum or the near infrared optical spectrum can be correlated somewhat with the tenderness of meat. These values of intensity or quality, however, are generally measured on the bulk of the meat with resolutions of a millimeter or more. There exists a variation of intensity at a much finer level of resolution, however. For example, the endomysium and the perimysium have substantially different color properties than that of the core of the muscle fiber. Even within the muscle fiber core, intensities and intensity variations can be noted. For the discussion below, the term “intensity” comprises a central tendency in intensity (e.g. mean, median or mode) in intensity value, whereas “intensity variations” comprise intensity variations within a sample (e.g. variances, standard deviations, or other such measures of variation). Furthermore, an intensity generally comprises a color attribute, which can be a specific HSL/HSV value (or other relative color value), a L*a*b* value (or other absolute color value), an RGB value, a CYMK value, or other value that is a mathematical transform of the original RGB values obtained from an RGB imager, an intensity value from a grayscale imager, an intensity value from an NIR or other spectrum-limited imager, or other imager-observed pixel values.

These intensities and intensity variations can be used as a feature of the meat for use in determining the tenderness. These intensities, either as central tendencies or as variances, are preferably defined with respect to specific ultrastructural elements. For example, consider the hue value of muscle fiber cores. In a first step, a specific muscle fiber will be isolated, such as by an area of contiguous pixels with a green channel intensity below a first predetermined threshold surrounded by contiguous pixels of green channel color above a second predetermined threshold. To limit false-positive muscle fibers with too large or small an area, the muscle fiber can additionally be limited to those areas comprising a number of pixels above a third predetermined threshold and a number of pixels below a fourth predetermined threshold.

It should be appreciated that there are a large number of image processing methods known in the prior art, including a variety of segmentation algorithms as will be described below, that can be used to delimit a muscle fiber and/or its core.

In a second step, the pixels comprising the muscle fiber core so defined are optionally eroded, so as to remove those pixels that are partially muscle fiber and partially surrounding endo/perimysium. In this case, the remaining pixels represent only muscle fiber. In a third step, a measure of central tendency of the pixels within the muscle fiber is determined, such as the average hue of the pixels. In an optional fourth step, a measure of the central tendency of the values determined in the third step is computed. In an alternative fourth step, a measure of the variation in the values determined in the third step is computed.

This assignment of individual pixels to specific ultrastructural features is of high value, as it can be used to improve on measures previously used for determining tenderness. For example, in the prior art, color has been used widely for the determination of tenderness, but the correlation is not good enough for commercial acceptance. In general, the measurement of color has entailed a gross average of color over a large area, either through use of a colorimeter with a large aperture, or with low-resolution digital imaging. In such cases, the color characteristic of the sample with include an average over a variety of ultrastructural features, including muscle fiber core, endo/perimysium, small interstitial fat deposits, small interstitial gristle deposits, blood vessels, nerves, and other features that can be small compared to the resolution of the method employed to determine color. Given the different color characteristics of these ultrastructural elements, the averaging of the signals for all of these different elements will necessarily confound real correlations and provide poorer overall correlations. In the present invention, indeed, the same color characteristic can be measured independently for each ultrastructural component, giving rise to a variety of different features for the same color characteristic.

One measure of intensity variations is simply to measure the overall variance in color either within a single channel (e.g. red, green or blue), within derived color channels (for example magenta, cyan or yellow) or within the hue, saturation, or lightness on a pixel-by-pixel basis. A preferable method of measuring this variance is to look at the pixel differences on adjacent pixels, such as the between each pixel and the pixel to its immediate right. The gross variance in color parameter does not distinguish between two massive blocks of color difference and a fine-grained variation. Looking at pixels that are adjacent to one another, however, does distinguish between the two scenarios.

It should be understood that the intensity and the intensity variance for a particular feature (e.g. red channel intensity) can be independently used as features. In illustration, the red channel intensity for muscle fiber core averaged over the entire muscle portion of the sample can be used as one feature, and the variance of the red channel intensity for muscle fiber core can be used as another feature.

Preparation of the images prior to feature analysis can improve the feature extraction. For example, individual red, green, and blue channels can be used for analysis. Alternatively, cyan, magenta, and yellow can be used. Furthermore, hue, lightness, and saturation can alternatively be used. In addition, useful manipulations of the data include subtracting either the blue channel or the green channel from the red channel. Also, the use of an absolute Lab color space, including the CIE 1976 L*a*b* color space, is convenient. In the following discussion, when referring to a color characteristic, any of the HSV, HSL, Lab, L*a*b* or similar parameters that are derivative of the measured RGB values and translated to a relative or absolute color system can be used in substitution for one another in the decision analysis algorithms.

### Topological Image Analysis

In addition to manipulating the color characteristics of the image, certain topological manipulations or analysis can also be useful. Such methods can often be improved by a variety of image preprocessing steps, which can include enhancing areas of light and dark by erosion and dilation, illumination equalization, and others.

For example, the endomysium can be seen in images as borders of somewhat lighter color around darker centers related to the meat fibers. These border areas can be traced using segmentation routines well-known in the prior art, including watershed segmentation, kmeans segmentation, histogram-based segmentation, edge-detection-based segmentation, level set segmentation, and others. In general, given that there is knowledge of the general size and shape of the muscle fibers under observation, model-based segmentation has strong application.

It should be noted that as with much image analysis, there is considerable flexibility in the use of imaging algorithms, and that multiple algorithms are often applied in a given analysis.

The output of such a topological analysis involves parameters related to the different segments. Such parameters include but are not necessarily limited to a statistical measure (e.g. mean, median, percentile, or variance) of the number of presumptive muscle fibers per area, the area of a muscle fiber, the relative degree of orientation of a muscle fiber (e.g. the ratio of the short to long axis), the ratio of muscle fiber core to endo/perimysium, etc.

In addition, as mentioned above, the color of the tissue in the muscle fiber core to the endo/perimysium, as well as the information derived from indicators, such as the pH within the muscle fiber core and in the periphery of the muscle fiber (endo/perimysium). For these color and indicator measures, it should be noted that the determination of color as a function of ultra-structure can be accomplished through the determination of the ultrastructural location of each pixel. Alternatively, such analysis can be performed solely through a study of variance, without knowledge of ultrastructural distribution of pixels. For example, if the muscle fiber core is one hue, and the endomysium surrounding the muscle fiber core is another hue, then a histogram of hue will be roughly bi-modal, with one peak being the hue of muscle fiber core, and the other peak being the hue of the endomysium. The present invention teaches that either method can be used.

In the case where spectrum-limited illumination is used, such as with autofluorescence, the directly measured grayscale values can be utilized. However, it can also be useful to look at the “difference” between the fluorescence and reflected light. This is most conveniently performed by looking either at the ratio or product of an autofluorescence value and that of a color characteristic (i.e. a ratio when the two are inversely related, and a product when the two are directly related). It can be convenient to subtract a constant from one or another of these values prior to the division or multiplication so as to remove a bias term and thereby accentuate the differences.

A similar methodology as that used with fluorescence can be conveniently employed when using polarization, as the absolute polarization response is accentuated in comparison with the reflected light color characteristics. It should also be noted that it can be useful to combine multiple parameters, such as fluorescence, polarization, and one or more color characteristics.

### Texture Analysis

Texture comprises a feature that is characteristic of the general fine-grained structure of an image, and include such notions as roughness, granulation and regularity.

Among the most valuable features for use in determining the tenderness are Local Binary Patterns (LBP). LBP are conventionally used for texture analysis, and meat ultra-structure can be considered such a texture. In general, there are two classes of LBP features, those that are rotation invariant and those that are rotation variant, and both of these can be used to good effect for determining meat tenderness. A description of the use of LBP features in determining meat tenderness is given below.

Images are scaled so that features of interest are on the order of five to 15 pixels in breadth. Initially, the size of the features that provide the greatest tenderness diagnostic may not be known beforehand, and a number of different scales are used, generally with the difference of between 20% and 250% resolution between different scales (i.e. from successive image scales of 1.0, 1.2, 1.44, etc. or 1.0, 2.5, 6.25, etc.). It should be noted that the same decision algorithm for determining meat tenderness generally will use features from different scales of the same image, wherein the different scales are sensitive to different ultrastructural of features in the meat.

Because images of meat are taken with fixed reference points on the meat sample, rotation invariant LBP's are generally not used. A standard LBP with 256 features can be conveniently used. The radius of the LBP is conveniently 1, 2 or three pixels. It should be noted that with a radius of two or three pixels, generally eight of the surrounding pixels are used in computing the LBP. For each radius, the pixels used are the four corners or alternatively the four midpoints of each of the sides. In this fashion, each radius still generates 256 potential features.

A form of contrast threshold can also be used in computing LBP. A predetermined threshold intensity difference between the central pixel and one of the surrounding pixels can be set, before which the surrounding pixel is considered to have a higher intensity than the central pixel. This forces a certain “contrast” between high intensity pixels and low intensity pixels. It should be noted that while LBPs are generally intensity invariant, the use of the contrast value does instill a small degree of intensity dependence since images with a small range of intensities, for example, will in general have fewer pixels with surrounding pixels above the predetermined contrast threshold.

These LBPs are computed for a variety of different image scales as described previously. It should be noted that while only a very small number of features will be used in tenderness determination, generally on the order of four to 10 features, hundreds or even thousands of LBPs will be generated in this fashion. In creating the decision algorithm, all of these features should be stored for analysis. In an operational system, however, only those features that are used in the decision algorithm will generally be computed and stored.

As mentioned previously, rotation invariant versions of LBPs can also be used. As before, LBPs with different radii can be used, and furthermore, the use of contrast values can also prove advantageous. It should be noted that each radius provides a different number of features in a rotation invariant LBP. Furthermore the number of features generated in a rotation invariant LBP is generally significantly less than that of a non-rotationally invariant LBP.

It should also be noted that the LBP features can be used to determine the tenderness in conjunction with other features unrelated to the ultrastructure of the meat. Such features can include, but are not limited to, the size, number and distribution of fat deposits, the size, number and distribution of gristle, the hue, lightness or saturation of the average color of meat, the ribeye area, the weight of the carcass, electrical impedance or other electrical characteristics of the meat, the near infrared spectrum of the meat, or other such characteristics. In addition, pixel-by-pixel variance in color as described herein above can also be used as additional features in a decision algorithm.

Other texture analyses that are well-suited for this application include transforms of the image information. Examples of such a transform includes conventional wavelet-analysis methods, which are well-known in the prior art. Such methods include energy-based wavelet analysis, generalized Gaussian density models, hidden Markov models, and more. Similar to such transform methods would be two-dimensional Fourier transform methods, which might be used, for example, to find peaks in spatial wavelengths as would be expected for muscle fibers. Such methods can be used instead of local binary patterns, as above, as well as in conjunction with local binary patterns.

### Determination of Meat Tenderness

The feature extraction methods above can provide from 3-4 to as many as dozens of features, for input to a decision algorithm, for use in determining meat tenderness in the step 300.

There are a variety of different decision algorithms that can be employed that use the features described above as input, and which output either a continuous tenderness measurement, or alternatively a discrete classification such as tender or tough. This latter classification type will generally correspond to a specific shear force threshold, such as the use of 19, 20, or 21 kg of sliced shear force as the threshold between tough and tender.

Conventional linear regressions, logistic regressions, Bayesian analysis, neural networks, support vector machines, and other methods currently in use as decision algorithms should be considered. Two methods, however, are of particular convenience. Before discussing these two methods, it should be noted that there are two distinct stages in the decision algorithm analysis. In a first stage, the features from a set of samples for which actual tenderness is been measured using conventional methodology such as sliced shear force or the Warner-Bratzler test are used to determine decision algorithm parameters. In the second stage, the decision algorithm parameters are used in conjunction with features measured from samples of unknown tenderness so as to compute a predicted tenderness. The discussion below primarily deals with the generation of the decision algorithm parameters in the first stage, as the second stage is a straightforward application of the decision algorithm well known in the prior art.

In the first method, the features can be used as inputs to random forests. The output to the random forest is the measured tenderness, which can be either a continuous pressure or conveniently a tough/tender classification. The use of random forests is generally useful in this application due to the large number of features that can be generated and the ability of random forests to handle large numbers of features.

In the second method, feature values are used as discrete thresholds in a binning procedure. For example, given two features A and B, a threshold for feature A and a threshold for feature B are selected such that they provide the greatest meat tenderness discrimination. Such a binning procedure can be extended to as many features as are necessary in order to provide adequate meat tenderness discrimination.

It should be noted that the objective function for tenderness discrimination can be of a variety of different formats. In a first format, the objective function can be the sum for all bins of the absolute value of the difference between the fraction of the tough meat in the bin and the average fraction of tough meat in the entire sample.

In a second format, the objective function can be the fraction of all the meat in bins that exceed a predetermined fraction that are tough or tender. Because tender meat that is in a tough bin is downgraded in value, tough bins that are only 40 to 60% tough are of considerably lower value than tough bins that are 70% to 100% tough. Therefore, it is preferable for tough bins to have greater than 60% tough meat, and more preferably greater than 70% tough meat, and most preferably greater than 75% tough meat. Likewise, in order to guarantee tenderness to consumers, a bin can be in general preferably greater than 90%, and more preferably greater than 95%, and most preferably greater than 97% tender.

It should be understood that a meat processing facility that incorporates meat tenderness determination already has a representative fraction of tough and tender meat. Such a facility already has marketing channels that allow it to sell meat of the default representative fraction. In a third format, three bins instead of two bins can be conveniently used. The first set of bins will be for tender meat, the second set of bins will be for tough meat, and the third set of bins will be for meat of the representative fraction. This is best illustrated through an example. In the tender bin, meat with a 95% or greater tender fraction is collected. In the tough bin, meat with the 60% or greater tough fraction is collected. In the default bin, meat with a 15 to 25% tough fraction is collected (assuming that the default representative fraction is 15 to 25%). Bins with 5 to 15% tough fraction contain tender meat in them to do not adequately reward higher fractions of tender meat (e.g. they do not meet the 95% threshold). On the other hand, bins with 25 to 60% tough fraction downgrade a very large amount of tender meat that is contained along with the tough meat.

One way of considering this third format is to enumerate objective goals. The first goal is to have tender bins in which tender meat exceeds a predetermined fraction of the meat. The second goal is to make the tender bins as large as possible. The third goal is to have tough bins in which tough meat exceeds a predetermined fraction of the meat. The fourth goal is to have a default bin in which the fraction of tough meat is preferably within 3% of the default representative fraction, and more preferably within 5% of the default representative fraction, and most preferably within 8% of the default representative fraction. The fifth goal is to reduce as much as possible the amount of meat in the default bin.

It should be noted that with four features, there will generally be 16 bins. In the previous paragraphs discussing alternative formats, it should be noted that the bins will generally be the sum of all of the bins needing a particular criterion. For example, if there are three bins where the fraction of tender meat exceeds the predetermined threshold, the tender bins will be the sum of all three bins.

It should be appreciated that values or attributes used in the decision algorithm need not be obtained through the use of high resolution imaging. For example, other information that is obtained that has potential value in an algorithm might include ribeye size, gender, age, marbling score, or other information. The features of the present invention are not necessarily meant to substitute completely for attributes or values obtained by other means. To the extent that such information improves the tenderness determination, it should be included in the decision algorithm.

### Use of High-Resolution Imaging to Guide Interpretation of Low-Resolution Imaging

It should be noted that even with high-resolution imaging, low-resolution imaging has significant value. That is, because of the small field of view generally available in high-resolution imaging, it is generally useful to also take a low-resolution image in order to measure meat characteristics over the entire sample. One example of this is to use a low-resolution image for determining the yield of the carcass, by measuring large fat deposits.

It can sometimes be difficult to explicitly find the location of fat and gristle deposits in detail, as the fat and gristle deposits can vary somewhat in color, texture and other characteristics from sample to sample. The high resolution image, however, provides additional characteristics of the different ultrastructural elements, such as the local binary patterns, the polarization, the autofluorescence, and the other features as described above.

Once the characteristics of the different ultrastructural elements has been determined in the high resolution images, the characteristics as would be captured in a low-resolution image can then be predicted by averaging the response over an area representing a pixel of the low-resolution image. For example, once a deposit of interstitial fat is identified on a high resolution image, the RGB characteristics of that area of the image can be averaged to give the expected response to fat on the low-resolution image, thus helping to identify fat on the low-resolution image. Where there are areas of fat and muscle intermixed, for example, in individual pixels of a low resolution image, the rough fraction of fat intermixed into the meat can be estimated by averaging together different fractions of the characteristics of the meat and fat as determined above.

### Use of Laser Scanners

Instead of conventional imaging, a laser scanner can be alternatively employed. The scanner can employ a reciprocating mirror or rotating prism, or polygonal mirrors and multi-mirror systems, as in conventional simple barcode and omni-directional barcode scanners. Such patterns produced by the scanner can comprise starbursts, lissajous or other complex shaped laser patterns. It should be noted that the use of laser scanners is a mature technological art, and includes not only the user of laser scanners for purposes of reading one and two dimensional bar codes at a distance, but also is used in detailed scanning of microarrays and other high-resolution biological assays. Furthermore, the resolution of such scanners can be sub-micron to tens of microns. The reflections from the laser scanner are recorded using a photodiode or other light-sensitive element that yields, potentially in conjunction with other electronic or digital equipment, a value of the reflectance as a function of time.

The laser scanner can be employed in such a manner as to obtain two-dimensional arrays of very high resolution, as in their use in reading biological microarrays. In such uses, laser scanners can be analyzed in much the same way as described above for use with CCD and CMOS imagers.

The wavelength of the laser is conveniently in the red part of the spectrum. However, in order to make a more focused beam, green and even blue lasers may be employed, especially since the ratio of absorbance across any two wavelengths is relatively constant for most meat samples. As will be described below, different lasers with different wavelengths can also be simultaneously employed to good effect.

As a point from a laser scanner traverses a piece of meat, it encounters various parts of the muscle fiber, including muscle fiber core and endomysium. The reflectance signals from these different parts of the muscle fiber will appear as a waveform. The present invention can yet furthermore be directed to a system for determining meat tenderness from a sample of meat in which a surface of the sample is exposed. The system can comprise a laser scanner configured to obtain high resolution waveforms that resolves the parts of individual muscle fibers along a line or curve across the meat. For this purpose, the diameter of the laser beam on the meat is preferably less than 25 microns, and more preferably less than 10 microns and most preferably less than 5 microns.

Muscles wherein the muscle fibers are smaller will show a higher frequency content in the waveform than muscles in which the muscle fibers are larger. If the pattern of the laser light is such that the line is oriented in different directions at different points in the laser beam trajectory, or in which multiple lasers are employed and oriented such that their laser beams are moving in different directions, then the spatial wavelength in multiple directions can be determined, thereby giving an indication of the directionality of muscle fibers—both the degree of asymmetry (e.g. the ratio of short to long axis), as well as the actual orientation of the muscle fibers relative to the gross muscle anatomy.

Altogether, a number of topological features from muscle fibers can be determined from analysis of waveforms, including muscle fiber diameter, muscle fiber area, muscle fiber degree of orientation, thickness of the endomysium, and ratio of area in endomysium to area in muscle fiber core. The ability to distinguish such features is dependent somewhat on the diameter of the laser scanner beam, and therefore smaller diameter beams are preferable to larger diameter beams.

Furthermore, the variance of the signal strength from different areas of the muscle fiber can be analyzed. This will show up as variance in signal strength of the waveform. The endomysium will generally have a relatively constant signal from sample to sample, whereas the muscle fiber core signals will have larger differences, depending on the physiology of the meat (e.g. fast versus slow twitch fibers). In general, it is advantageous to utilize a laser scanner in which signals from endomysium can be distinguished from signals from muscle fibers.

More than one laser can be employed, using different wavelengths. For example, fat and vasculature and nerve tissue will show different ratios of signals at the different wavelengths relative to muscle fiber. Furthermore, certain specular, diffuse and other reflections that do not represent true signals from the meat tissue will show as positions at which the signal ratios at the different wavelengths are distinct from the ratios shown by meat tissue.

In the case of multiple lasers with multiple wavelengths, the lasers can, through the use of beam synthesizers/splitters, be arranged so that the beams simultaneously and coincidentally impinge on the meat, so that the ratio of signals at each particular location can be determined. Alternatively, the lasers can be spatially uncoupled, so that the waveforms are independently analyzed for features, and these features for the different wavelengths be then compared.

It should be appreciated that this laser scanner can also be employed to determine gross characteristics of the meat. For example, if the scanner scans across the entire extent of the meat, and a large number of traversals are made of the meat, the scan can be used to determine characteristics such as yield, marbling characteristics and lean meat area. This individual lines represent a statistical sampling of the surface of the meat, and given the ability to distinguish fat from lean meat, the rough proportions of the area that are fat and lean meat can be determined, wherein the more lines across the meat, and the more random their location on the meat, the better sampling and more statistical accuracy that can be expected.

For example, if we consider the beams to constitute a grid on the surface of the meat, the spacing of the grid will determine the rough accuracy of the gross characteristics analysis. A conventional camera system has a resolution of approximately a square millimeter, and so a spacing of approximately 1 mm in laser scanning would be similar in spatial resolution. However, a camera system cannot determine fat versus lean meat in each pixel, and requires a few pixels for such determination. However, a laser scanning system with a 1 mm grid would have a much finer resolution of lean meat versus fat, and could analyze this on the scale of tens or small hundreds of microns. Therefore, the true resolving power of fat versus lean meat is better at a given resolution for the laser scanning system than for a camera system.

The grid of beams imposed on the meat can be rectilinear, or it can be of other patterns. In either case, the fat and meat aspects can be interpolated to give a complete description. Alternatively, the information from the laser scanning can be placed into a transfer function determined in the following fashion. A large number of ribeye or other steaks are analyzed by both imaging means as well as by a laser scanner. From comparing the two types of data, a transfer function is determined which, given the laser scanning data, gives “gold-standard” information as determined by the imaging means. This would potentially allow some under-sampling in the spatial dimension by the laser scanning system.

It can be that there are two different systems employed—one to determine the meat tenderness, which uses a fine beam with very high spatial resolution, and a separate beam with lower resolution and which traverses a larger area to determine gross carcass characteristics.

### System Summary

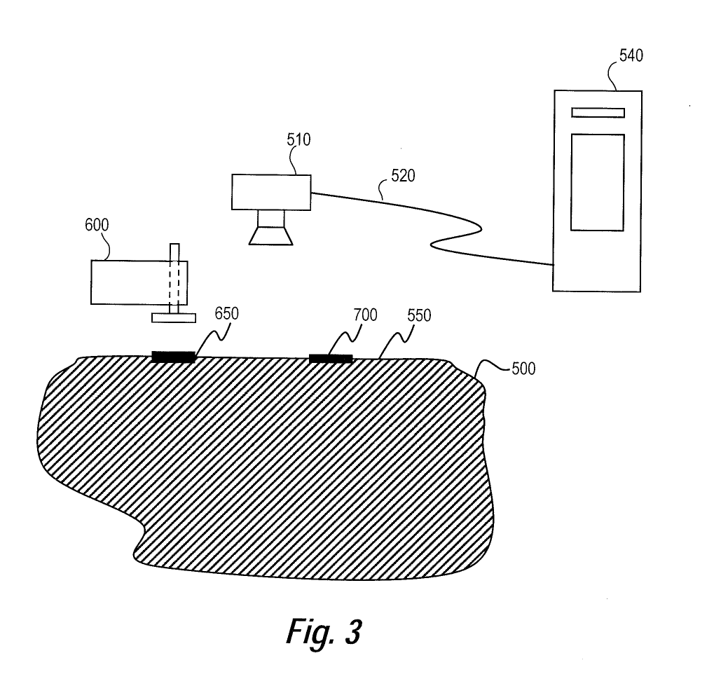

FIG. 3A is a schematic diagram of one embodiment of a system of the present invention. A meat sample 500 comprises one end of a carcass split between the 12^{th} and 13^{th} ribs, as is conventionally performed as part of USDA grading. The top surface 550 comprises the surface that is normally graded or imaged in conventional systems. A high-resolution imager 510 is focused on the surface 550, and comprises usually a CMOS or CCD imager with lenses that can be telecentric or near-telecentric. A calibration 700 is placed either on or near to the meat surface 550, which comprises color references (e.g. to correct for sample-to-sample differences in illumination) and/or distance references. If the calibration 700 comprises distance references (e.g. the lenses are not telecentric), the calibration is preferably placed on the meat surface 550.

An optional applicator 600 places indicator 650 on the surface 550. This applicator 600 can be either a contact applicator, as shown in the figure, or can alternatively be a standoff applicator that operates by spraying, ink-jet applying, or other similar means. An applicator 600 that operates in a standoff position can conveniently be accompanied by a mask (not shown) that delimits the area in which the indicator 650 is applied.

Note that both the calibration 700 and the indicator 650 should be within the field of view of the imager 510.

The imager 510 is connected to a computer 540 by means of a high-speed transmission cable 520, preferably capable of transferring hundreds of megabits or more per second. The images captured by the imager 510 are large, and little time is available for data transfer.

The computer 540 comprises software with two functionalities. A first functionality is that of image analysis, which extracts features from the images transferred to the computer 540 via the cable 520 from the imager 510. A second functionality is that of decision algorithm execution, whereby the features are used to determine a measure of meat tenderness. While the functionalities are shown in the figure as being performed within a single computer 540, it is also convenient to have either multiple computers 540—one being used for image analysis and another being used for decision algorithm execution—or by multiple CPU's with specialized function. It should be appreciated as well that the image analysis and/or decision algorithm execution can be performed by or in conjunction with special chips, such as FPGAs or digital signal processors (DSPs).

The two functionalities can also be executed within a single CPU either in a monolithic program, as separate threads within a program, or as two separate programs. Whatever the specific software configuration, these two functionalities are generally discussed within this specification as two separate functionalities, with data from the imager being transferred to the image analyzer to produce features, and the features being transferred to the decision algorithm executor for producing measures of meat tenderness.

### Summary of Terms

This Summary of Terms provides a convenient condensation of terminology used in this specification, which should not be limiting and should be considered in combination with further explication elsewhere in this specification, or as used or understood by those skilled in the art.

Muscle fiber comprises a surrounding layer of connective tissue such as endomysium around a muscle fiber core.

Lean muscle comprises tissue rich in muscle fiber, to the exclusion of non-lean-muscle tissues, which comprise fat, gristle, nerve, blood vessels, other connective tissue, etc.

Statistical measures comprises the mean, the median, a percentile value, a variance, a standard deviation, or similar statistical measure, such as additional measures that can be derived from the above.

A feature comprises one or a small number of values derived from the pixel values of the imager. Such features can comprise color features, topological features, physiological features (e.g. pH or protease levels), texture features, and more. The purpose of a feature is, roughly speaking, to reduce the very large amount of information in an image (often millions of pieces of information, as an image can have millions of pixels, each with multiple intensity values) into a small number of values for use in a decision algorithm. Features often involve statistical measures. It should be noted that the calculation of these features from images can be called “calculating” the features, “computing” the features, “extracting” the features, or other such action connoting the derivation of the features from the underlying images. The image analysis for extraction of the features is generally (though not exclusively) performed by a digital computer, which can be supplemented with digital signal processors or other chips optimized for image analysis.

Texture analysis comprises a value or small number of values that incorporate information about the fine-grained structure of an image. Such information can include local pattern analysis, pixel-to-pixel contrast analysis, and more.

Local pattern analysis comprises both local binary patterns as well as numerous other algorithms that have similar or formally identical effects.

Topological features comprise features related to the physical arrangement of ultrastructural elements, both in an absolute sense (e.g. a size, distance or area) as well as relative sense (e.g. relative direction, relative size, relative distance, relative area).

Color values comprise hue, saturation, lightness, red value, green value, blue value, magenta value, cyan value, yellow value, Lab space value, L*a*b* space value, or any other value derived from obtaining images from specific spectral regions, and which can involve the comparison of such values.

Muscle fiber ultrastructure comprises those features of the muscle fiber that relate to distinct parts of the muscle fiber, such as the muscle fiber core, the endomysium, and the perimysium. In general, if visual or imaging means are used to observe such muscle fiber ultrastructure, a resolution is preferred that can distinguish the various distinct parts of the muscle fiber ultrastructure.

A physiological state indicator comprises the application of a chemical indicator to the surface of the meat, where the indicator interacts with the meat structure or components so as to reveal some aspect of the meat physiological sate. Examples of such states can include the pH, calcium ion levels, or protease activities.

Decision algorithms comprise any mapping or other process of assigning features from the high-resolution imaging, and which can additionally include values or attributes determined by means other than high-resolution imaging, into a meat tenderness determination.

Meat tenderness determination comprises the derivation of both qualitative and quantitative measures. In one sense, meat tenderness can comprise a value that can be compared with a predetermined value, such that being on one side or another of the predetermined value indicates the tenderness of the meat. In another sense, meat tenderness can comprise a set of categories, such as “tender”, “tough” and “intermediate” that is assigned to the meat. In yet another sense, meat tenderness can comprise a probability of the meat being a member of a category.

### Many Embodiments Within the Spirit of the Present Invention

It should be apparent to one skilled in the art that the above-mentioned embodiments are merely illustrations of a few of the many possible specific embodiments of the present invention. It should also be appreciated that the methods of the present invention provide a nearly uncountable number of arrangements.

Numerous and varied other arrangements can be readily devised by those skilled in the art without departing from the spirit and scope of the invention. Moreover, all statements herein reciting principles, aspects and embodiments of the present invention, as well as specific examples thereof, are intended to encompass both structural and functional equivalents thereof. Additionally, it is intended that such equivalents include both currently known equivalents as well as equivalents developed in the future, i.e. any elements developed that perform the same function, regardless of structure.

For example, local binary patterns is a form of a large set of possible local pattern analysis methods. Such methods look within a diameter of a small number of pixels, preferably less than 12 pixels, and more preferably less than 8 pixels and most preferably less than 6 pixels. Within this small number of pixels, variations in illumination will tend to be unimportant. While a useful standard for such pattern analysis to be local binary patterns, it should be appreciated that there are numerous algorithms that are apparently different from local binary patterns, but which a formally either equivalent or very similar in effect.

Furthermore, there are many different types of image segmentation available for distinguishing muscle fibers, or areas of fat, gristle or other types of non-lean-meat. These segmentation routines have generally the same goals, and achieve them through different means but usually similar results. The use of one or more of these segmentation methods have similar effects in the determination of meat tenderness.

In the specification hereof any element expressed as a means for performing a specified function is intended to encompass any way of performing that function. The invention as defined by such specification resides in the fact that the functionalities provided by the various recited means are combined and brought together in the manner which the specification calls for. Applicant thus regards any means which can provide those functionalities as equivalent as those shown herein.

What is claimed is:

1. A method for determining tenderness of a meat sample in which a surface of the sample is exposed, comprising:
imaging the meat surface with a high resolution imager capable of resolving muscle fiber ultrastructure;
extracting at least one feature from the high resolution images, wherein the extracting uses resolution of muscle fiber ultrastructure; and
determining meat tenderness using an automated decision algorithm that operates on the at least one extracted feature.

2. The method of claim 1, wherein the imager has a resolution of less than 25 microns.

3. The method of claim 1, wherein the imager comprises a multispectral imager.

4. The method of claim 1, wherein the at least one extracted feature comprises a comparison of a feature within muscle fiber core and the feature in endomysium.

5. The method of claim 4, wherein the feature comprises a color value.

6. The method of claim 1, wherein the at least one extracted feature comprises a statistical measure related to a topological feature of muscle fibers.

7. The method of claim 6, wherein the topological feature of muscle fibers is selected from the group consisting of muscle fiber diameter, muscle fiber area, muscle fiber degree of orientation, thickness of the endomysium, and ratio of area in endomysium to area in muscle fiber core.

8. The method of claim 1, wherein the step of extracting further comprises texture analysis.

9. A method for determining tenderness of a meat sample in which a surface of the sample is exposed, comprising:
scanning the surface with a laser whose beam diameter is smaller than smaller than a predetermined diameter;
recording the light reflected from the surface as a waveform;
extracting at least one feature from the waveform, wherein the feature is related to muscle fiber ultrastructure; and
determining meat tenderness using an automated decision algorithm that operates on the at least one extracted feature.

10. The method of claim 9, wherein the predetermined diameter of the laser beam is less than 25 microns.

11. The method of claim 9, wherein the at least one extracted feature comprises a comparison of a feature within muscle fiber core and the feature in endomysium.

12. The method of claim 9, wherein the at least one extracted feature comprises a statistical measure related to a topological feature of muscle fibers.

13. The method of claim 12, wherein the topological feature of muscle fibers is selected from the group consisting of muscle fiber diameter, muscle fiber area, muscle fiber degree of orientation, thickness of the endomysium, and ratio of area in endomysium to area in muscle fiber core.

14. The method of claim 9, further determining a gross characteristic of the meat selected from the group consisting of yield and marbling.

15. A system for determining meat tenderness from a sample of meat in which a surface of the sample is exposed, comprising:
a laser scanner with a beam diameter less than a predetermined diameter;
a recorder that records the laser light reflected from the surface, creating a waveform;
an analyzer coupled to the recorder for extracting features from the waveform relating to ultrastructural aspects of individual muscle fibers; and
a decision algorithm executor coupled to the analyzer, the executor being configured to determine a measure of meat tenderness from the extracted features.

16. The system of claim 15, wherein the predetermined diameter of the laser beam is less than 25 microns.

17. The system of claim 15, wherein the at least one extracted feature comprises a comparison of a feature within muscle fiber core and the feature in endomysium.

18. The system of claim 15, wherein the at least one extracted feature comprises a statistical measure related to a topological feature of muscle fibers.

19. The system of claim 18, wherein the topological feature of muscle fibers is selected from the group consisting of muscle fiber diameter, muscle fiber area, muscle fiber degree of orientation, thickness of the endomysium, and ratio of area in endomysium to area in muscle fiber core.

20. The system of claim 15, wherein the executor is further configured to determine a gross characteristic of the meat selected from the group consisting of yield and marbling.
